(19) United States
(12) Patent Application Publication
(10) Pub. No.: US 2017/0357660 A1
(43) Pub. Date: Dec. 14, 2017

(54) A Method for Automatically Presenting to a User Online Content Based on the User's Preferences as Derived from the User's Online Activity and Related System and Computer Readable Medium

(71) Applicant: Canecto ApS, Kgs. Lyngby (DK)

(72) Inventor: Per Damgaard Husted, Virum (DK)

(21) Appl. No.: 15/540,038

(22) PCT Filed: Jul. 14, 2016
(86) PCT No.: PCT/DK2016/050251

§ 371 Date: Jun. 27, 2017

(30) Foreign Application Priority Data
Aug. 24, 2015 (DK) PA 2015 70542

(51) Int. Cl. G06F 17/30; G06F 17/18

(52) U.S. Cl. CPC G06F 17/3089; G06F 17/3087; G06F 17/30902; G06F 17/18; G06F 17/30702

(57) ABSTRACT

The invention relates to a method for automatically presenting to a user online content (C) based on the user's preferences as derived from the user's online activity, wherein the method comprises: generating data structures (IP) representing the online content (C) accessed by the user on one or more user devices; identifying from the generated data structures (IP) one or more patterns (P) representative of the user's preferences in terms of online content (C); and identifying and presenting to the user the online content (C) corresponding to said patterns (P).

### FIELD OF THE INVENTION

The invention relates to the technical field of online content search, particularly to automatic presentation to a user of online content according to the user's preferences.

### BACKGROUND OF THE INVENTION

The amount of information on the Internet makes the search for relevant information a difficult and time-consuming task for an individual. Moreover, conventional keyword searches imply a high probability that the most useful information to an individual in a specific situation will actually not be found. Hence, there is a long-felt need in the technical field of online content search of overcoming the abovementioned drawbacks of the state-of-the-art.

US 2008/0216176 A1 discloses a web page recommendation system comprising a browsing history database, a long and short term user profile database, and a manager agent module. The manager agent module uses a score calculating algorithm to analyse the web browser preferences of the user wherein the result of this score calculating algorithm is stored in the long and short term user profile databases. The manager agent module further uses a configuration table stored in a configuration file to decide on a sequence for displaying web page recommendations to the user.

### ASPECTS OF THE INVENTION

The first aspect of the invention is to provide an improvement to the state-of-the-art. The second aspect of the invention is to solve the abovementioned drawbacks of the prior art by providing a solution that automatically presents relevant online content to the user, thus avoiding him a time-consuming and cumbersome operation, which likely results in poorly relevant information to be displayed or in relevant information not to be displayed at first.

### DESCRIPTION OF THE INVENTION

The aforementioned aspects of the invention are achieved by a method for automatically presenting to a user online content (e.g., news, scientific articles, etc.) based on the user's preferences as derived from the user's online activity (e.g., visits on web sites), wherein the method comprises:
for each online content accessed by the user on one or more user devices (e.g., a mobile phone, a tablet, a laptop, a PC, etc.):
extracting at least one keyword (e.g., Chelsea, Ferrari, etc.);
extracting a set of metadata elements;
assigning a weight to the keyword and to one or more metadata elements in the set;
generating at least one first data structure including the keyword, the set of metadata elements and the weights;
identifying from the generated first data structures one or more patterns, each pattern comprising at least one keyword or at least one keyword and one or more metadata elements (e.g., F1+English), which patterns are representative of the user's preferences in terms of online content; and
identifying and presenting to the user the online content (e.g., URLs) corresponding to said patterns.

The invention selects and presents online content to the user at the right time and at the right place according to an analysis of the user's online activity. As a consequence, the invention makes search of online content straightforward to the user and, at the same time, enhances the perceived quality of the output compared to conventional keyword searches.

In an advantageous embodiment of the invention, the method further comprises the step of extracting at least one definition for each keyword. Since often the same keyword may have different meanings (e.g., Chelsea may be a city or a football team), the extraction of the definitions of a keyword permits better interpreting the intentions of the user and consequently refining the selection of recommendations presented to the user.

Advantageously, assigning a weight may be carried out by counting the number of times a keyword or a metadata element is found in all the generated first data structures.

In an advantageous embodiment of the invention, the set of metadata elements comprises one or more amongst source, time, date, location and language of the accessed online content. The latter selection enables a precise evaluation of the usual as well as the current preferences of the user (e.g., the user may have different preferences during July due to the Tour De France or while visiting a foreign capital on a weekend trip).

In an advantageous embodiment of the invention, the step of identifying one or more patterns comprises running a weighted clustering algorithm. Herein, a weighted clustering algorithm is referred to an algorithm that by analysing all the generated first data structures identifies one or more clusters (i.e., the patterns) of keywords and/or definitions and/or metadata elements that represent the user preferences—this can be mathematically expressed, for example, by associating to each cluster a value, e.g., depending on the weights of the elements constituting the cluster. This type of algorithm has the advantage with respect to other suitable methods of identification of patterns of offering a superior outcome, which more closely represents the user's preferences. Clustering algorithms are usually categorized according to the clustering analysis performed and therefore can be, for example, referred to as connectivity-, centroid-, distribution- or density-based.

In an advantageous embodiment of the invention, the step of identifying the online content comprises: generating a text search string including a pattern; and feeding said text search string to a web crawling software. Herein, a web crawling software is referred to a software able to scan the Internet and find a list of URLs related to the text search made. This embodiment has the advantage of automatically and promptly providing a list of URLs from the outcome of the pattern identification.

In an advantageous embodiment of the invention, the method further comprises the steps of:
for each identified online content:
extracting at least one keyword;
extracting a set of metadata elements;
assigning a weight to the keyword and to one or more metadata elements in the set;
generating at least one second data structure including the keyword, the set of metadata elements and the weights;
presenting to the user the identified online content whose second data structure matches said patterns.

Since some of the online content found, e.g., by the web crawler, may be less relevant than expected, this embodiment has the advantage of assuring a higher quality of the suggested online content presented to the user by basically comparing the identified online content with the identified patterns.

In case the identified online content does not include any keyword that matches the identified patterns, the original online content may be indexed again in order to create new keywords, which will eventually generate identified patterns that will match the keywords of the identified online content.

In case the identified online content includes only one keyword that matches the identified patterns out of all the searched keywords, other elements such as source, language, geography may be taken into account, and the online content that best matches the updated pattern will then be selected.

Advantageously, for each identified online content, the method may further comprise the step of extracting at least one definition for each keyword.

Advantageously, for each identified online content, assigning a weight may be carried out by counting the number of times a keyword or a metadata element is found in all the generated second data structures.

In an advantageous embodiment of the invention, the method further comprises the step of monitoring the user's online activity for updating the weights in the first data structures. This implies some that keywords and/or definitions and/or metadata elements may change their weights according to the user's current interest (e.g., the keyword “Tour De France” will not have a high weight anymore after Tour De France will be over). Hence, this embodiment has the advantage of continuously adjusting the system according to the current user's preferences, thus avoiding the system to be felt inadequate.

Note that the steps of the method do not necessarily need to be carried out in the order described above but may also be performed in a different order, and/or simultaneously.

Also, the aforementioned aspects of the invention are achieved by a system for automatically presenting to a user online content based on the user's preferences as derived from the user's online activity, wherein the system comprises at least one user device including a processing unit and a database, wherein the processing unit is configured to carry out the method as described above and the database is configured to store the generated first and/or second data structures. Advantageously, in order to relieve the user device from the computational burden, a server may instead fully or partly perform the steps of the method. Note that all the aforementioned advantages of the method are also met by the system.

Also, the aforementioned aspects of the invention are achieved by a computer readable medium (e.g., a non-transitory computer readable medium), wherein the computer readable medium comprises program instructions for causing a computer (e.g., a server or a user device) to carry out the method as described above. Note that all the aforementioned advantages of the method are also met by the computer readable medium.

Also, the aforementioned aspects of the invention are achieved by a data structure for representing online content, the data structure being embodied on a computer readable medium (e.g., a non-transitory computer readable medium), wherein the data structure comprises at least one data unit for storing a keyword and an associated weight, and a set of data units for storing one or more metadata elements and associated weights. Advantageously, said data structure may further comprise a data unit for storing at least one definition of said keyword. The data structure (in the remainder also referred to as an Interest Point (IP)) is a structured, simplified way to describe the meaning of online content (e.g., a web page, an RSS feed, etc.) in a unified manner, so that the identification of patterns amongst the data structures, and thereby the determination of the user's preferences, is more easily enabled.

Hereafter, the invention will be described in connection with drawings illustrating nonlimiting examples.

### BRIEF DESCRIPTION OF THE DRAWINGS

FIG. 1: High level overview of a PIA.

FIG. 2: IP architecture.

FIG. 3: IP mining process.

FIG. 4: High level overview of the online content selection process.

FIG. 5: IP weighing principle.

FIG. 6: Clustering and generation of text strings.

FIG. 7: High level overview of the output selection and quality match process.

FIG. 8: Components of the output module.

FIG. 9: High level overview of the interaction analysis and feedback process.

FIG. 10: Alternative applications of the invention.

### PREFERRED EMBODIMENTS OF THE INVENTION

In a preferred embodiment of the invention, a Personal Internet Agent PIA selects and presents relevant online content C to the user.

Firstly, the PIA collects and analyses data related to the user's online activity and, as a result, produces a set of IPs. An IP is a data structure which is representative of the core meaning of an online content C (e.g., a web page or a document). In particular, an IP includes a set S of metadata elements M, each representing a key attribute of the online content C, and associated weights W representing the importance of the different elements to the user. The PIA generates IPs for all types of online content C that the user has accessed such as the online browsing history on the user's mobile devices and PCs, GPS locations, etc. All IPs are saved in a database, for example, on a server of the service provider.

Secondly, the PIA uses the IPs to identify which online content C should be presented to the user. For example, this may be achieved by a weighted clustering algorithm WCA, which analyses the IPs and identifies patterns P in the interrelationships among them. The most relevant patterns P are the ones that indicate the interests of the user at the time being. The identified patterns P are then used to generate the search strings T that will be employed (e.g., by a web crawling software WC) to search for relevant online content C. The latter may be presented to the user, for example, on a mobile phone application, web pages, RSS feeds, etc.

Finally, the user's online activity may be continuously monitored 113, so as to update 114 the weights W of the IPs and consequently the user preferences.

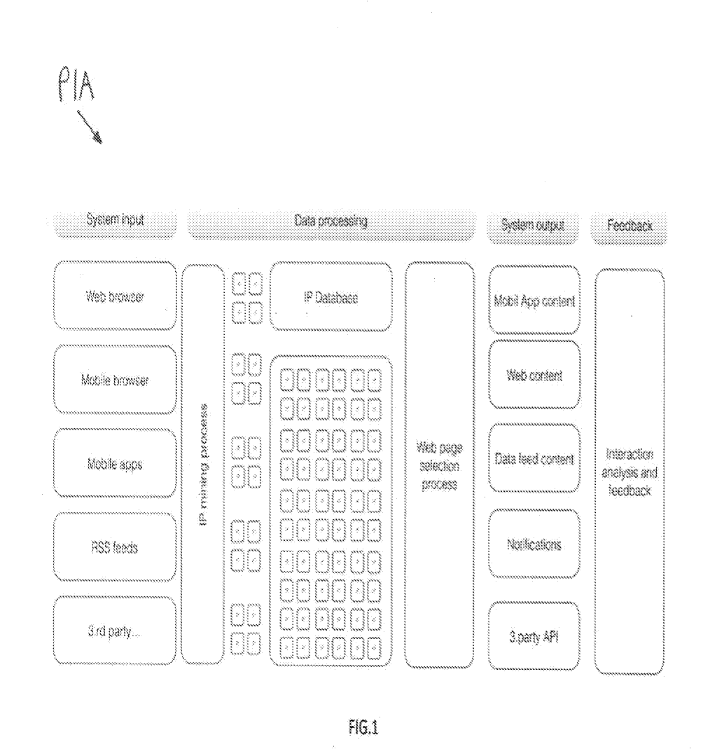

FIG. 1 shows an overview of an exemplary PIA, which comprises the following modules: (i) input module; (ii) data processing module; (iii) output module; and (iv) feedback module.

The input module encompasses the sources that generate input to the PIA in terms of online content C. Such sources may comprise any platform from which user activity can be recorded such as a web browser, a mobile browser, a mobile phone application, an RSS feed, a third party application, etc. Data is extracted from these sources either in real-time or subsequently by loading files corresponding to the accessed online content C in batch sequences (e.g., in case of new users).

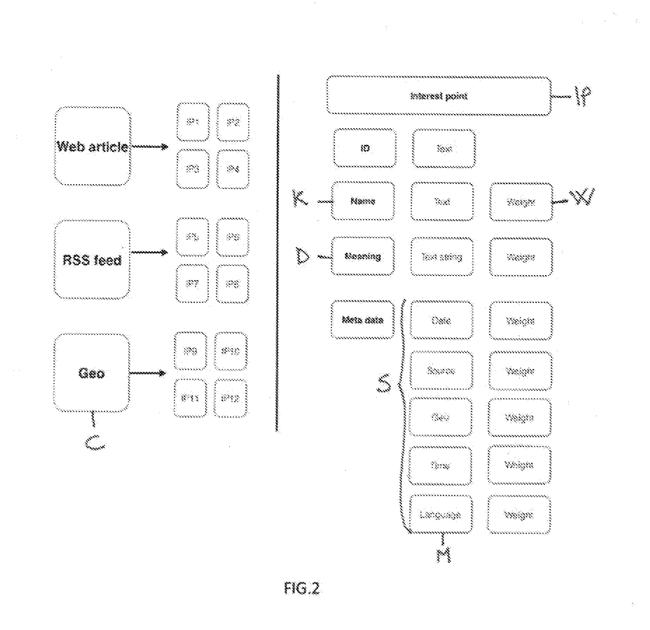

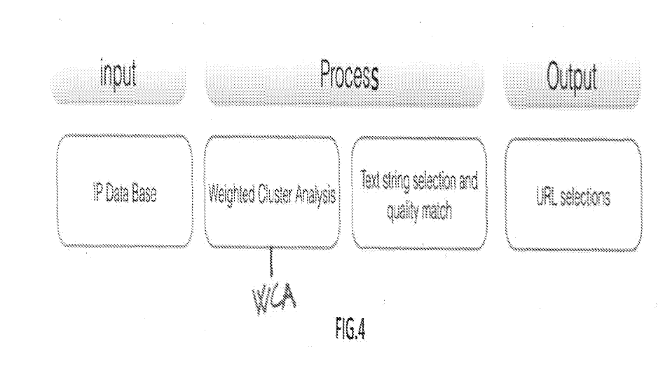

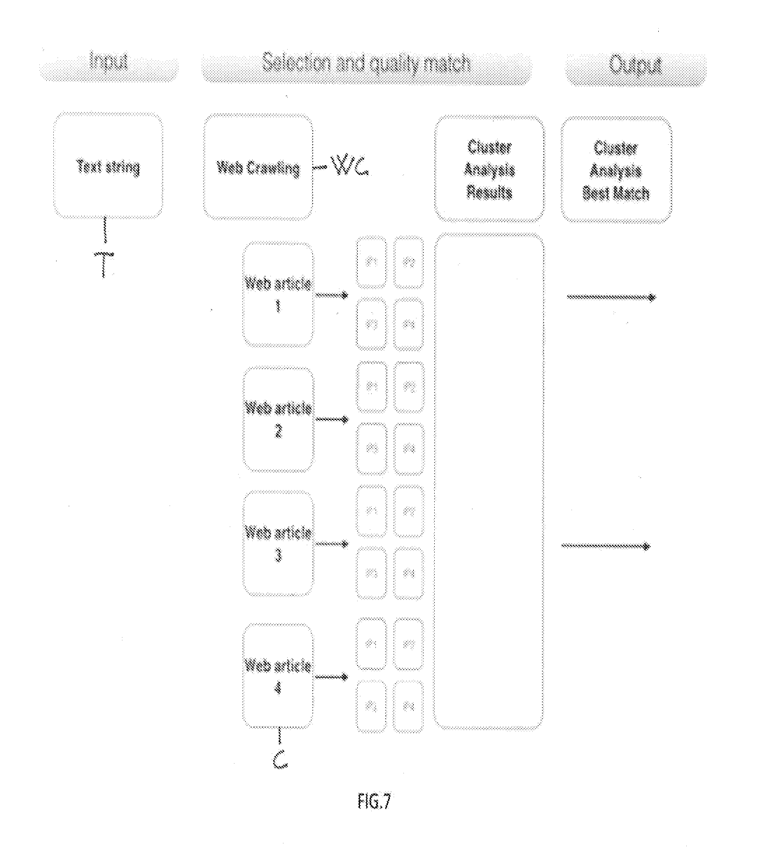

The data processing module selects the online content C that is relevant to the user by generating IPs and identifying patterns P in the IP population. Hence, the purpose of the data processing layer is to categorize and analyse the user's online activity, and to select relevant online content C. This is accomplished by: (i) generating IPs; (ii) mining the elements of each IP from the online content C accessed by the user (ref. FIGS. 1-2); (iii) saving the IPs in a database (ref. FIG. 1); and (iv) selecting the online content C to be presented to the user by deriving the user's preferences from an analysis of the interrelationships among the IPs (FIG. 1, FIG. 4 and FIG. 7).

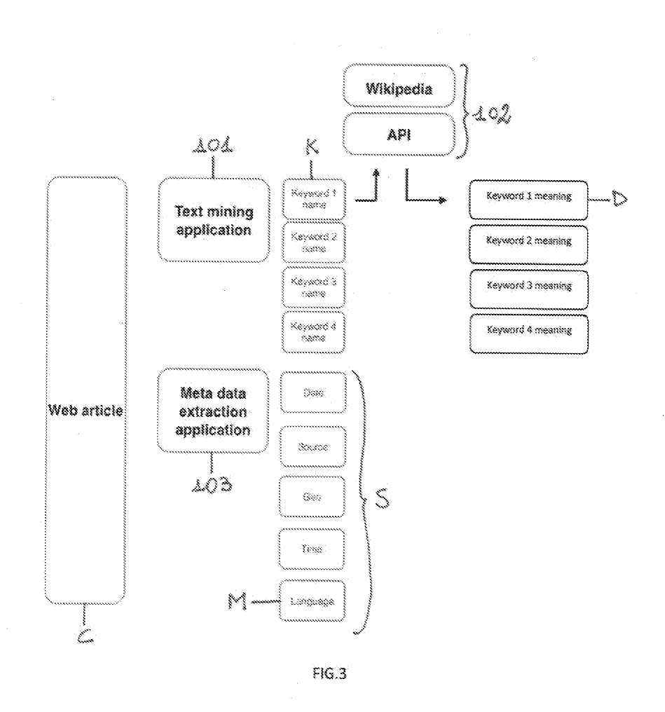

FIG. 2 shows an exemplary architecture of an IP and FIG. 3 shows how the elements of the IP are extracted from an online source such as a web article. A text mining application extracts 101 the keywords K from the web article. A Wikipedia API extracts 102 the definition(s) D (also referred to as meaning(s)) of the extracted keywords K—this operation is carried out to understand the user's intention for reading the article and to help identify the relationships to similar IPs. A metadata application extracts 103 metadata elements M from the online source, such as the date the source was accessed (Date), the source itself (Source), the geographical position from where the user accessed the source (Geo), the time spent accessing the source (Time) and the language of the source (Language).

All IPs are saved in a database, whose purpose is to enable pattern recognition in the IPs. The database is designed such that patterns P across the elements of the IPs can be identified in a data mining process. IPs may be never removed from the database; nevertheless, the allocation of weights W in the IPs will ensure that older IPs will gradually have lower weights W.

FIG. 4 shows the online content C selection process, whose purpose is to identify patterns P in the user's online activity that can be used to determine the user's search intents and interests. The process uses the IP database as an input and comprises the identification of patterns P (e.g., by means of a weighted cluster algorithm WCA), the selection of the text search strings T and, optionally, a quality match. The process output may be a list of URLs to be prompt to the user.

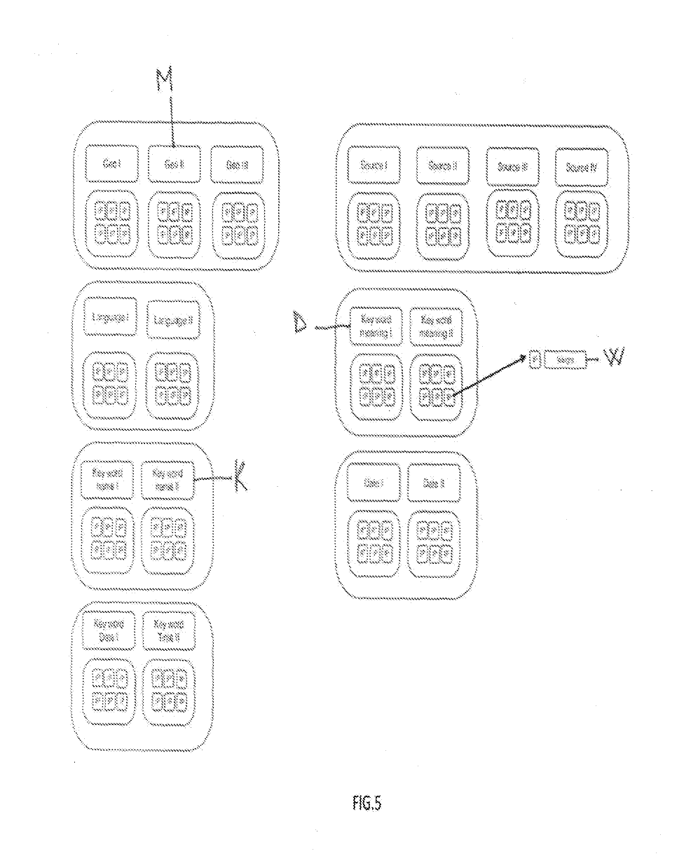

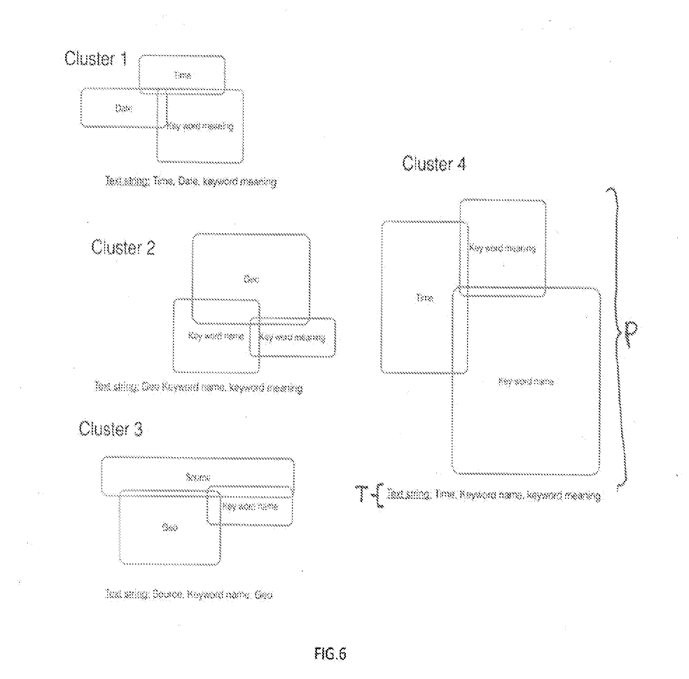

The purpose of the weighted cluster analysis is to identify the most significant patterns P in the user's online activity. The elements in the IPs and their corresponding weights W are the basis for the cluster analysis (ref. FIGS. 5-6). For example, if the language “English” has a weight W (e.g., a total weight, which represents the combination of the single weights W) higher than the other languages, then clusters/patterns P including English are of higher value to the user and thereby they should be considered as more important than clusters including the other languages. The outcome of the weighted cluster analysis is therefore a mapping of the current user preferences into ranked clusters, whose elements are used to generate text strings T that are the input to the online content C selection process.

The aim of the online content selection process is to find online content C that is as close as possible to the content that is basis for the highest valued cluster. Basically, the process finds online content C (e.g., by means of a web crawling software WC) thanks to an online search performed with the generated text strings T (ref. FIG. 7). Optionally, in order to ensure the highest quality match of the resulting online content C with the derived user preferences, IPs may be generated for each found online content C. The generated IPs are then matched against the clusters to derive which of the found online content C matches or is closest to them. The best matches will then be selected and presented to the user.

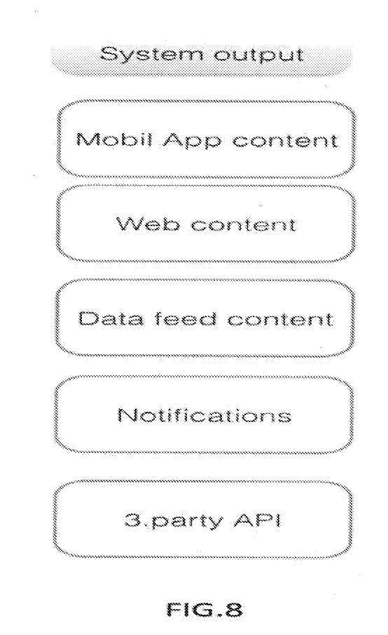

The output module encompasses the channels on which the selected online content C is presented to the user. The list of URLs identified in the previous process can be presented to the user as content in (ref. FIG. 8): a mobile phone application, a mobile or a web browser, a data feed (e.g., RSS), a notification (e.g., an SMS, an MMS, an email, etc.), an API for third party use, etc.

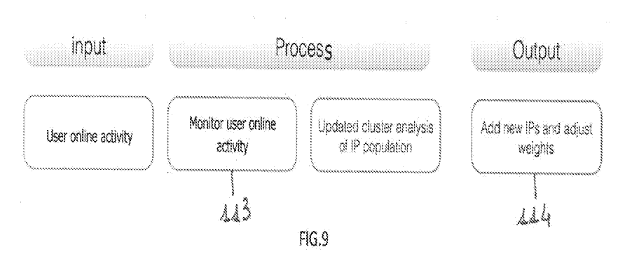

Optionally, a feedback module monitors 113 the user's online activity and accordingly updates 114 the weights W in the IPs, so that eventual changes in the user's preferences are recorded (ref. FIG. 9).

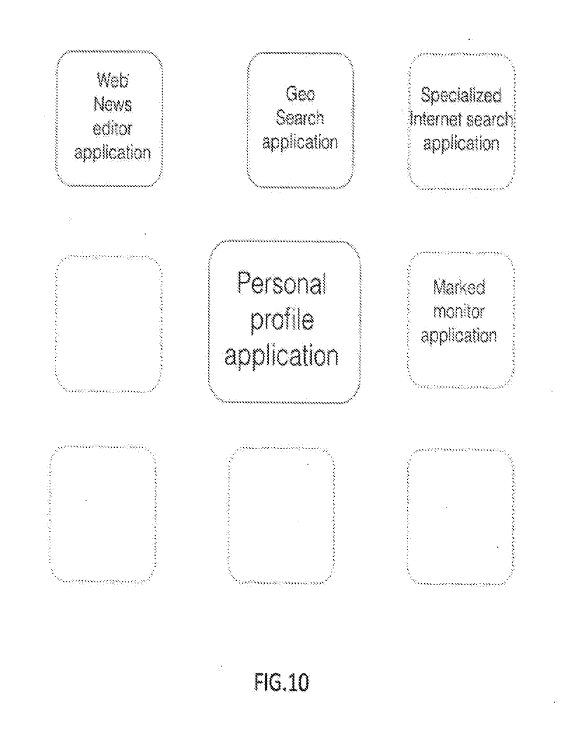

Note that the use of a personal profiling technology such as that described in the latter embodiment is mainly targeted to the selection of web news articles. There are, however, other application areas in which the technology may advantageously be used, such as (ref. FIG. 10): geo search applications (i.e., applications that based on the location and the preferences of the user suggests him, e.g., relevant nearby places), specialized Internet search applications (i.e., applications that perform automatic searches on specific topics) and market monitoring applications (i.e., applications that monitoring the user's online activity for marketing purposes).

### Example 1: Polar Bear Article

The user accesses a web page via a mobile phone application. The web page contains an article about polar bears' reaction to the climate change in the Arctic.

The PIA (which may run on the mobile phone itself or on a server) retrieves the article's URL.

The text mining application accesses the web page for identifying languages, text patterns, word density, etc. and consequently extracting 101 the keywords K representing the content C of the article. For example, the extracted keywords K could be:

1) Polar bear

2) Climate change

3) Arctic

4) Ice season

5) Reproductive success

The 5 keywords will then be converted into 5 corresponding IPs.

The metadata extraction application will simultaneously access the same web page and extract 103 metadata from the same article. For example, the extracted set S of metadata elements M could be:
Date: the date the source was accessed
Source: the name of the web page, e.g., www.wwf.org
Geography: the location of the user when she accessed the web page
Time: the time spent on the web page
Language: the language in which the web page was written
Publication date: the date the article was published

The metadata elements M will then populate each of the 5 IPs.

Optionally, a Wikipedia API, for example, extracts 102 the definition D of each keyword K. For example, the extracted definitions D could be:
Polar bear: carnivorous bear
Climate change: weather patterns
Arctic: polar region
Ice season: no result
Reproductive success: passing of genes onto the next generation

Thus, 4 out of 5 IPs will be enriched with a definition D.

The PIA will now define a web search string T to search for similar articles. The web search string T will be defined based upon derived user preferences and the knowledge of the article as represented via the IPs. The user preferences may be derived thanks to a weighted cluster analysis, which identifies patterns P in the IPs generated from the article. For example, as a result of the weighted cluster analysis, the web search string T could satisfy the following requirements:
Contain the keywords K and the definitions D from the IPs in the article
Only look for articles in English
Prioritize articles that are newer than 6 months old
Prioritize articles from wwf.org, un.org and cnn.com
Prioritize articles from USA

The PIA will then employ the web search string T to perform a web search via, for example, a web crawler WC, whose output may be a list of search results.

Optionally, the PIA may generate IPs from the articles in the list of search results (all or only the top ones) in the same way it was performed for the original article. This makes it possible to compare the articles to the web search string T requirements and rank the list of search results so that the PIA can suggest to the user articles that are as close as possible to her preferences as well as to the content C of the polar bear article.

### Example 2: What is of Interest to Me?

The user accesses the application via her mobile phone, where she expects to be presented with online content C (e.g., as a list of web pages) that is of utmost interest to her in the given situation. In order to do so, the following procedure may be followed by the PIA.

Web search strings T may be generated according to situation-specific patterns P in the IP population that match with the user's current situation in terms of time, date and position. For example:
Time: the user prefers reading articles on the stock market in the morning before 09:00 when the stock exchange opens—this will generate a corresponding web search string T.
Date: the user prefers reading articles on Premier League Football on Tuesdays during the football season—this will generate a corresponding web search string T.
Geography: the user prefers reading articles generated in the city where she lives—this is a general requirement, which will thus be included in all web search strings T generated for the user.

Web search strings T may also be generated according to more general patterns P in the IP population. For example:
The last five articles the user read were about holiday in France—this will generate a corresponding web search string T.
The topic that the user spent most time reading about the last 30 days was on the new iPhone—this will generate a corresponding web search string T.
The user prefers reading articles in English, but sometimes also in German—this is a general requirement, which will thus be included in all web search strings T generated for the user.

The way articles are selected from the search strings T follows the same procedure as described in the previous example.

1. A method for automatically presenting to a user online content (C) based on the user's preferences as derived from the user's online activity, wherein the method comprises:
for each online content (C) accessed by the user on one or more user devices:
extracting (101) at least one keyword (K);
extracting (103) a set (S) of metadata elements (M);
assigning a weight (W) to the keyword (K) and to one or more metadata elements (M) in the set (S);
generating at least one first data structure (IP) including the keyword (K), the set (S) of metadata elements (M) and the weights (W);
identifying from the generated first data structures (IP) one or more patterns (P), each pattern (P) comprising at least one keyword (K) or at least one keyword (K) and one or more metadata elements (M), which patterns (P) are representative of the user's preferences in terms of online content (C); and
identifying and presenting to the user the online content (C) corresponding to said patterns (P).

2. The method according to claim 1, wherein the method further comprises the step of extracting (102) at least one definition (D) for each keyword (K).

3. The method according to claim 1, wherein the set (S) of metadata elements (M) comprises one or more amongst source, time, date, location and language of the accessed online content (C).

4. The method according to claim 1, wherein the step of identifying one or more patterns (P) comprises running a weighted clustering algorithm (WCA).

5. The method according to claim 1, wherein the step of identifying the online content (C) comprises:
generating a text search string (T) including a pattern (P); and
feeding said text search string (T) to a web crawling software (WC).

6. The method according to claim 1, wherein the method further comprises the steps of:
for each identified online content (C):
extracting (101) at least one keyword (K);
extracting (103) a set (S) of metadata elements (M);
assigning a weight (W) to the keyword (K) and to one or more metadata elements (M) in the set (S);
generating at least one second data structure (IP) including the keyword (K), the set (S) of metadata elements (M) and the weights (W);
presenting to the user the identified online content (C) whose second data structure (IP) matches said patterns (P).

7. The method according to claim 1, wherein the method further comprises the step of monitoring (113) the user's online activity for updating (114) the weights (W) in the first data structures (IP).

8. A system for automatically presenting to a user online content (C) based on the user's preferences as derived from the user's online activity, wherein the system comprises at least one user device including a processing unit and a database, wherein the processing unit is configured to carry out the method according to claim 1 and the database is configured to store the generated first and/or second data structures (IP).

9. A computer readable medium, wherein the computer readable medium comprises program instructions for causing a computer to carry out the method according to claim 1.
